(19) United States
(12) Patent Application Publication
(10) Pub. No.: US 2004/0003584 A1
(43) Pub. Date: Jan. 8, 2004

(54) Method and apparatus for converting or otherwise utilizing radiation pressure to generate mechanical work

(76) Inventor: Joseph Michael Clay, Houston, TX (US)

Correspondence Address: PAULA D. MORRIS & ASSOCIATES, P.C., 10260 WESTHEIMER, SUITE 360, HOUSTON, TX, 77042, US

(21) Appl. No.: 10/393,114

(22) Filed: Mar. 19, 2003

Related U.S. Application Data
(60) Provisional application No. 60/365,470, filed on Mar. 19, 2002.

(51) Int. Cl. H05B 1/00

(52) U.S. Cl. 60/203.1

(57) ABSTRACT

An apparatus and method provided for utilizing radiation pressure provided by a light wave to generate mechanical work. The apparatus includes a containment chamber constructed to contain the propagation of light waves therein along a predetermined reflected light wave path. The apparatus also an optic switch selectively operable in an open mode and a closed mode, wherein the open mode allows a light wave to enter the containment chamber and the closed mode prevents escape of the light wave from the containment chamber. Further, the apparatus has a reflective mirror positioned at one end of the containment chamber. The reflective mirror has a first reflective surface. The apparatus also includes second reflective surface positioned at a second end of the containment chamber, wherein the predetermined light path extends between the first and second reflective surfaces; and wherein repeated contact of the light path against the first reflective surface allows radiation pressure repeatedly acting upon the first reflective surface to cause the movable reflective mirror to travel along a predetermined path, thereby producing mechanical work.

### BACKGROUND OF THE INVENTION

This application is a non-provisional application claiming the benefit of the filing date of Provisional Application Serial No. 60/365,470 filed on Mar. 19, 2002 (now pending). The above application is hereby incorporated by reference for all purposes and made a part of the present disclosure.

The present invention relates generally to a method and apparatus for harnessing the energy present in an electromagnetic light wave and converting this energy to a form of work, for example, mechanical work.

### BRIEF SUMMARY OF THE INVENTION

In one aspect of the invention, an apparatus is provided for utilizing radiation pressure provided by a light wave to generate mechanical work. The apparatus also includes a containment chamber constructed to contain the propagation of light waves therein along a predetermined reflected light wave path. The apparatus further includes an optic switch selectively operable in an open mode and a closed mode, wherein the open mode allows a light wave to enter the containment chamber and the closed mode prevents escape of the light wave from the containment chamber. Further, the apparatus has a reflective mirror positioned at one end of the containment chamber and second reflective surface positioned at a second end of the containment chamber. The reflective surfaces are positioned so that the predetermined light path extends between the first and second reflective surfaces. The apparatus operates so that repeated contact of the light path against the first reflective surface allows radiation pressure repeatedly acting upon the first reflective surface to cause the movable reflective mirror to travel along a predetermined path. In this way, mechanical work is generated.

In a preferred embodiment, the inventive apparatus utilizes at least one prism as a light switch and a containment chamber including one or more highly reflective mirrors to reflect propagating light waves in the chamber. In one operative mode, the mirrors absorb radiation pressure and reflect light, thereby converting some of the light energy in the containment chamber into mechanical energy and/or generating work. In one embodiment, the inventive method involves positioning at least two prisms adjacent to one another and by effecting compression between two adjacent faces or walls thereby reduce or eliminate the reflective optical interface between the two, thereby allowing light radiation to pass through as if there were no interface.

In another aspect of the invention, a method is provided for utilizing radiation pressure provided by a light wave to generate mechanical work. The inventive method includes the initial step of providing a containment chamber for containing propagation of a light wave and positioning, in a first location of the containment chamber, a movable reflective mirror having a first reflective surface. Then, a second reflective surface is positioned in a second location in the containment chamber, whereby the locations and orientations of the first and second reflective surfaces are predetermined to define, at least partially, a predetermined reflective light path. The method then provides for the step of introducing a light wave into the containment chamber. This introducing step includes directing the introduced light wave in the direction of one of the reflective surfaces, thereby causing the light wave to propagate between the first and second reflective surfaces along a predetermined light path for a plurality of cycles. According to the method, the light wave contacts the first reflective surface and causes radiation pressure to act on the first reflective surface, and then reflects against the initial reflective surface at a generally normal angle.

Preferably, the method further includes repeating the introducing step with respect to another light wave, whereby repeated contact of the first reflective surface with the light wave causes radiation pressure to move the first reflective surface along a predetermined path. More preferably, the positioning step also includes the step of positioning a second movable reflective mirror in the containment chamber, the second reflective mirror having the second reflective surface, and the step of directing the introduced light wave causes the light wave to repeatedly contact the second reflective surface and radiation pressure to repeatedly act upon the second reflective surface, thereby effecting travel of the second reflective surface along a second predetermined path and producing mechanical work.

Most preferably, the method also includes the step of providing a prism and positioning the prism such that the prism volume forms a portion of the containment chamber and at least one face of the prism forms a boundary of the containment chamber. Thus, the introducing step includes directing the light wave into the prism through said one face.

### BRIEF DESCRIPTION OF THE DRAWINGS

FIG. 1 is simplified schematic of an apparatus, such as a photon engine, for utilizing radiation pressure associated with light waves to generate mechanical work;

FIG. 2 is a schematic of one embodiment of a piston assembly for use with the inventive apparatus;

FIG. 3 is a schematic of one alternative embodiment of a photon engine according to the present invention;

FIGS. 4a and 4b are illustrations of prisms that may be used in conjunction with a photon engine according to the present invention;

FIG. 5 is a schematic of yet another embodiment of the inventive apparatus; and

FIG. 6 is a schematic illustrating one method according to the invention.

### DETAILED DESCRIPTION OF THE INVENTION

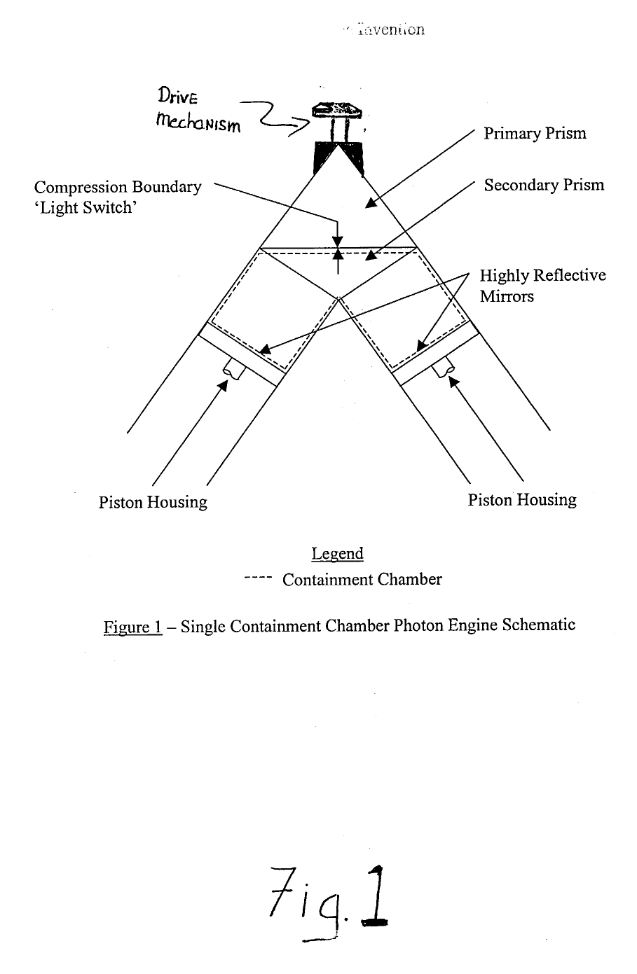

FIGS. 1-6 are provided to illustrate an apparatus and/or method according to the present invention, and embodies various aspects of this invention.

The present invention relates generally to the utilization of radiation pressure inherent or obtainable from a light wave to produce work, for example, mechanical work. The source of this radiation pressure is provided by a light source, or more specifically, propagating electromagnetic waves directed from a light source into or within the apparatus (i.e. “containment chamber”) of the invention. Generally, the electromagnetic waves are directed into a containment chamber through at least one operable prism that functions in a switching mode. In a preferred embodiment, a primary prism and a secondary prism are used, and are operated together to provide a light switch injection valve, which either reflects light entering the first prism or passes light into the containment chamber.

Operation of the light switch (shown in FIG. 1) is based on a simple optical phenomenon wherein two individual media( i.e. prisms) may be compressed along an interface so that the media combined act as one. First, light is introduced into the primary prism at a predetermined angle. With the light switch in the closed or non-operative mode, the light reflects off a back face or wall of the primary prism. To open the switch and place it in the operative mode, the primary and secondary prisms, i.e., the first and second individual media, are compressed against each other (or more particularly, the secondary prism compresses against the primary prism) through operation by an external driving device. In doing so, the boundary between the two prisms, i.e., the common face, is removed, and the two media function as one. Light directed into a first prism, therefore, passes through the boundary with the second prism, through the second prism and enters a containment chamber. It is further advantageous to direct light into the primary prism at a predetermined angle so that the light enters and then propagates within the containment chamber at an angle that is normal to a reflective mirror movably mounted within the chamber.

With light contained in the containment chamber, the light switch is closed. Thus, the light ray or light in the containment chamber maintains columniation and continuously propagates therein. More precisely, the contained light reflects off a first reflective mirror at a normal angle, then against the prism at a nearly 45° angle or other predetermined angle, and then reflects off a second mirror also at a normal angle. These three reflections make up one full cycle which is repeated within a known, predetermined time frame. The time frame also preferably corresponds to the operating frequency of the light switch: between closed and open modes. During each cycle, the light cycles between the three reflective surfaces at high rate so that radiation pressure is transmitted to or through the two mirror surfaces thereby converting or translating the energy of the light wave to mechanical work, i.e., movement of the mirror. In preferred embodiments, the mirror is operatively connected to a piston and contained in a cylinder assembly (the cylinder preferably does not absorb the light) so as to operate as an engine.

To facilitate description of the invention, a brief explanation of certain concepts is first provided.

The light wave which is the object of the inventive method is an electromagnetic wave. Electromagnetic waves being an energetic medium transport linear momentum making it possible to exert a mechanical pressure on a surface by shining a light on it the surface. It should be understood that this pressure is small for individual light photons. But given a sufficient number of photons a significant mechanical pressure may be obtained.

Maxwell (J. C.) showed the resulting momentum p for a parallel beam of light that is totally absorbed is the energy U divided by the speed of light c.

$$p = \frac{U}{c}$$

If the light beam is totally reflected the momentum resulting at a normal incidence to the reflection is twice the total absorbed value.

$$p = \frac{2 U}{c}$$

These examples represent the two ends of the spectrum for momentum transfer. The totally absorbed beam at one end that demonstrates the totally inelastic case where the particles stick together and the most kinetic energy is lost, typically, to another form of energy such as thermal energy or deformation. At the other end of the spectrum, a totally reflected beam demonstrates a completely elastic collision where kinetic energy is conserved.

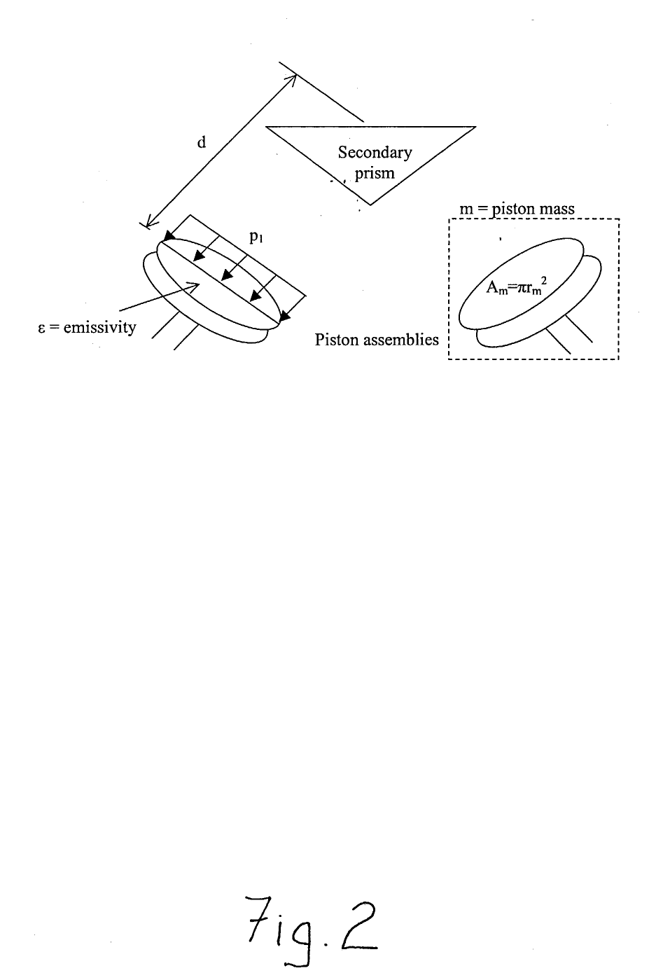

With reference to FIG. 2, the following sections provide calculations on the power produced by an apparatus and method, i.e. an engine, according to the invention. The calculations can be divided into four sections: Force (F); Time (T); Work (W); and Power (P).

The following details the force calculation on a single mirror, with surface area, Aₘ, and an initial radiation pressure entering the containment chamber, p₁, until the radiation pressure is effectively zero after z number of bounces.

F_{0-z}=p₁Aₘ+p₂Aₘ+p₃Aₘ+ . . . +p_{z}Aₘ

The relationship between each radiation pressure bounce can be represented as a function of surface emissivity, ε.

p₂=εp₁, p₃=εp₂, p₄=εp₃, . . . , p_{z}=εp_{z-1}

Inserting the radiation pressure relationship between bounces off all surfaces results in the following relationship:

$${F}_{0 - z , total} = {p}_{1} {A}_{m} + ϵ {p}_{1} {A}_{m} + {ϵ}^{2} {p}_{1} {A}_{m} + … + {ϵ}^{z} {p}_{1} {A}_{m}$$

$$or$$

$${F}_{0 - z , total} = {\sum }_{n = 0}^{z} {ϵ}^{n} {p}_{1} {A}_{m}$$

For a single mirror every fourth bounce should be added to the force calculation:

$${F}_{0 - z , single mirror} = {p}_{1} {A}_{m} + {ϵ}^{4} {p}_{1} {A}_{m} + {ϵ}^{8} {p}_{1} {A}_{m} + … + {ϵ}^{4 z / 4} {p}_{1} {A}_{m}$$

$$or$$

$${F}_{0 - z , single mirror} = {\sum }_{n = 0}^{z / 4} {ϵ}^{4 n} {p}_{1} {A}_{m}$$

The time or duration of the force is found by dividing the distance the light travels by the velocity of light.

t=zd/c

The work of a resultant force on a body equals the change in its kinetic energy. The work calculation for a single piston head is as follows.

$$W = \frac{1}{2} m ( {v}_{2}^{2} - {v}_{1}^{2} ) {\to }^{ {v}_{1} = 0 } W = \frac{1}{2} {mv}_{2}^{2}$$

The relationship between velocity, acceleration and force are as follows.

v=at

F=ma [symbol] a=F/m

Therefore,

v=F/m^{t}

To obtain the work on a single mirror the force, time and velocity equation are substituted into the work equation.

$${W}_{single mirror} = \frac{1}{2} \frac{{( {\sum }_{n = 0}^{z / 4} {ϵ}^{4 n} {p}_{1} {A}_{m} )}^{2} {( \frac{zd}{c} )}^{2}}{m}$$

For an emissivity that is nearly equal to one the force exerted on the second mirror is approximately equal to the force on the first mirror. Hence, the sum for work in a single containment chamber is as follows.

$${W}_{containment chamber} \approx 2 {W}_{single mirror} = \frac{{( {\sum }_{n = 0}^{z / 4} {ϵ}^{4 n} {p}_{1} {A}_{m} )}^{2} {( \frac{zd}{c} )}^{2}}{m}$$

Power is the time rate of doing work. If a single chamber operated continuously, the power would have to account for a full operation or cycle of the cylinder that consists of compression and expansion phases where the force is applied during half the compression phase and removed during the expansion phase.

$${P}_{containment chamber} = \frac{1}{4} \frac{{W}_{containment chamber}}{t}$$

$$or$$

$${P}_{containment chamber} = \frac{{( {\sum }_{n = 0}^{z / 4} {ϵ}^{4 n} {p}_{1} {A}_{m} )}^{2} ( \frac{zd}{c} )}{4 m}$$

For a photon engine with 4 containment chambers the power would be as follows.

$${P}_{photon engine} = 4 {P}_{containment chamber} = \frac{{( {\sum }_{n = 0}^{z / 4} {ϵ}^{4 n} {p}_{1} {A}_{m} )}^{2} ( \frac{zd}{c} )}{m}$$

Now turning to FIGS. 1-6, these Figures illustrate several embodiments of an apparatus according to the invention. Specifically, each of FIGS. 1, 3, and 5 depict an exemplary photon engine according to the invention.

FIG. 1 shows a schematic of a pair of Piston Housings, a Secondary Prism, a Primary Prism (made of a high index of refraction material, >ca. 1.4 such as Crystalline Quartz) a pair of highly reflective mirrors, one disposed in each piston housing, the volume defined by the mirrors and secondary prism further defining a Contaimnent Chamber within a photon engine, a Compression Boundary between the two prisms that can be controlled to form a light switch and a mechanism, for example a piezoelectric mechanism that drives the first Prism and functionally causes the Compression Boundary Light Switch to operate (i.e. allowing light to pass into the containment chamber in a controlled fashion).

FIG. 2 is a schematic of one embodiment of a piston assembly of mass m (and a particular area) and emissivity E, being irradiated by a light flux p₁ over a distance d by radiation transmitted through the Compression Boundary Light Switch thereby causing a mechanical force on the piston assembly.

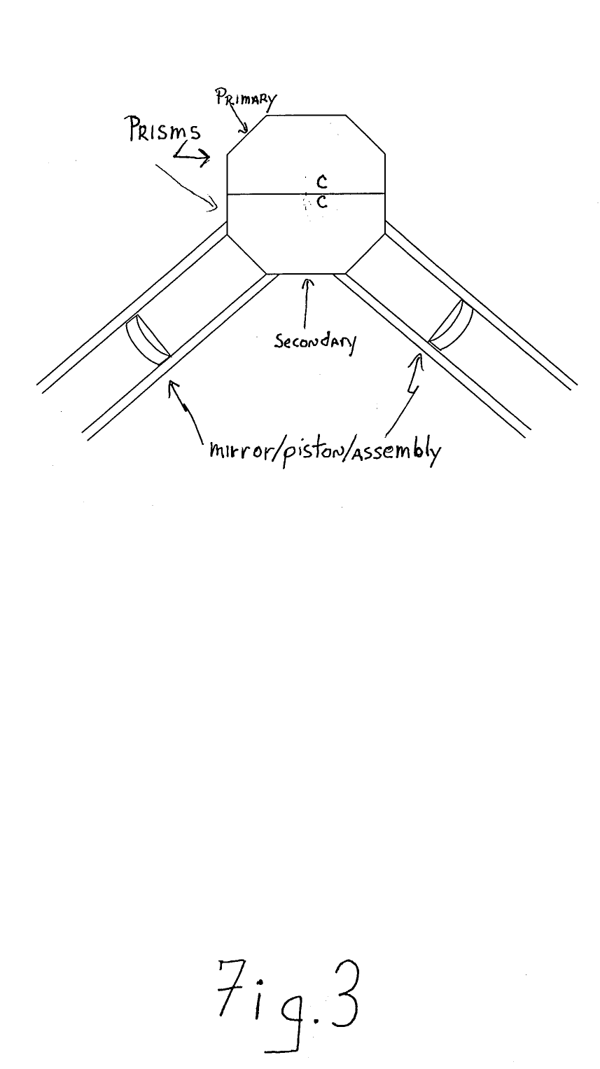

FIG. 3 is a schematic of one alternative embodiment of a photon engine showing a pair of prisms, primary and secondary, that when mated along their (“C” in each case) boundary surface form an octagonal cross section switch element that may be further connected with at least a pair of mirror/piston/cylinder assemblies to form a photon engine.

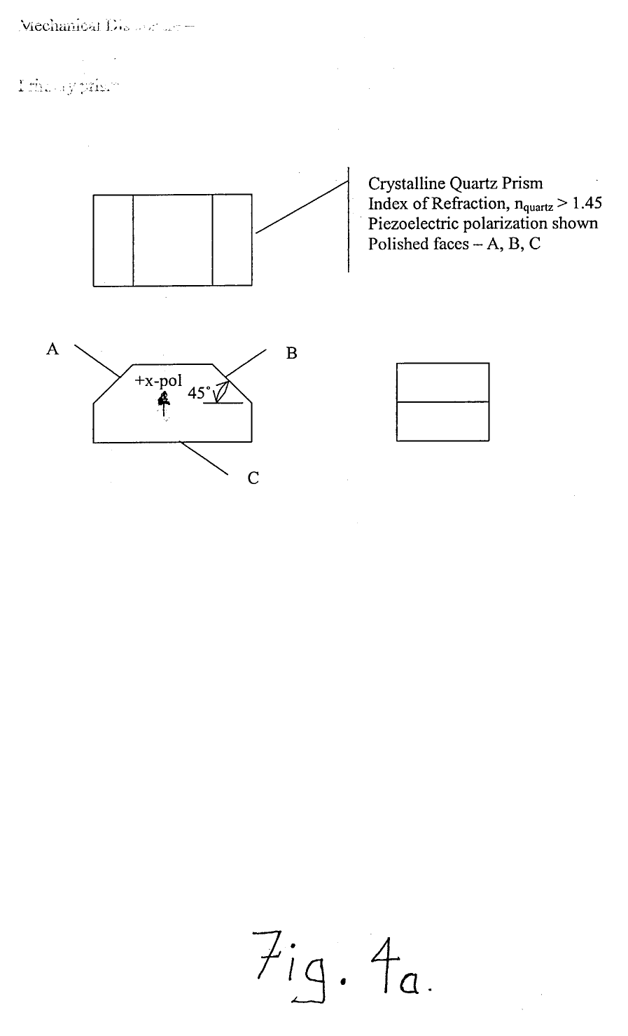

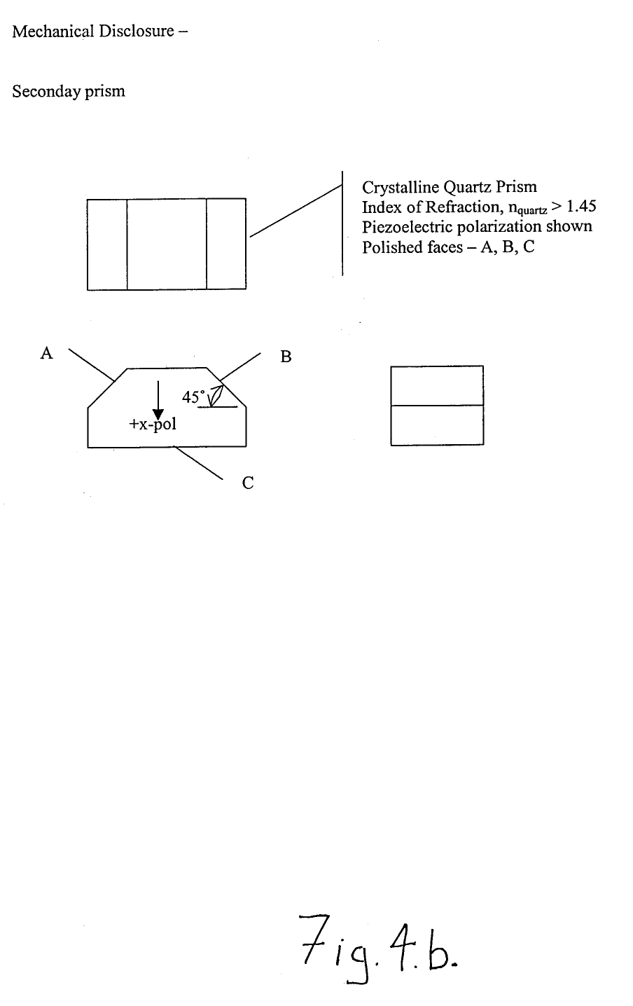

FIGS. 4a and 4b illustrate prisms in a geometric configuration for a light switch injection valve that may be useful in certain embodiments of a photon engine.

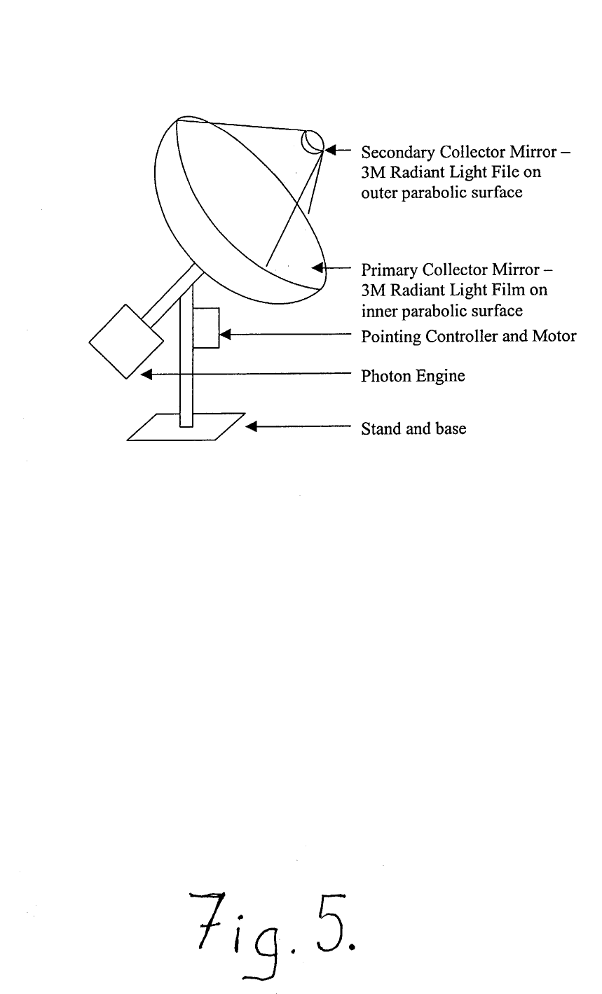

FIG. 5 is a schematic of a system to convert radiant energy into a different form of energy or work. The system comprises at least a stand/base member, a pointing controller (for directing the system to a source of radiation) including a motor drive mechanism; a Primary Collector Mirror having an inner parabolic surface covered or coated in a 3M(™) Radiant Light Film, the Mirror mounted on the stand member, the Primary Collector further having at least one parabolic Secondary Collector Mirror mounted thereon, the Secondary Collector also having a 3M Radiant Light File on its outer surface, a light guide for receiving concentrated light from the Secondary Collector Mirror(s) and transmitting the concentrated light to a Photon Engine.

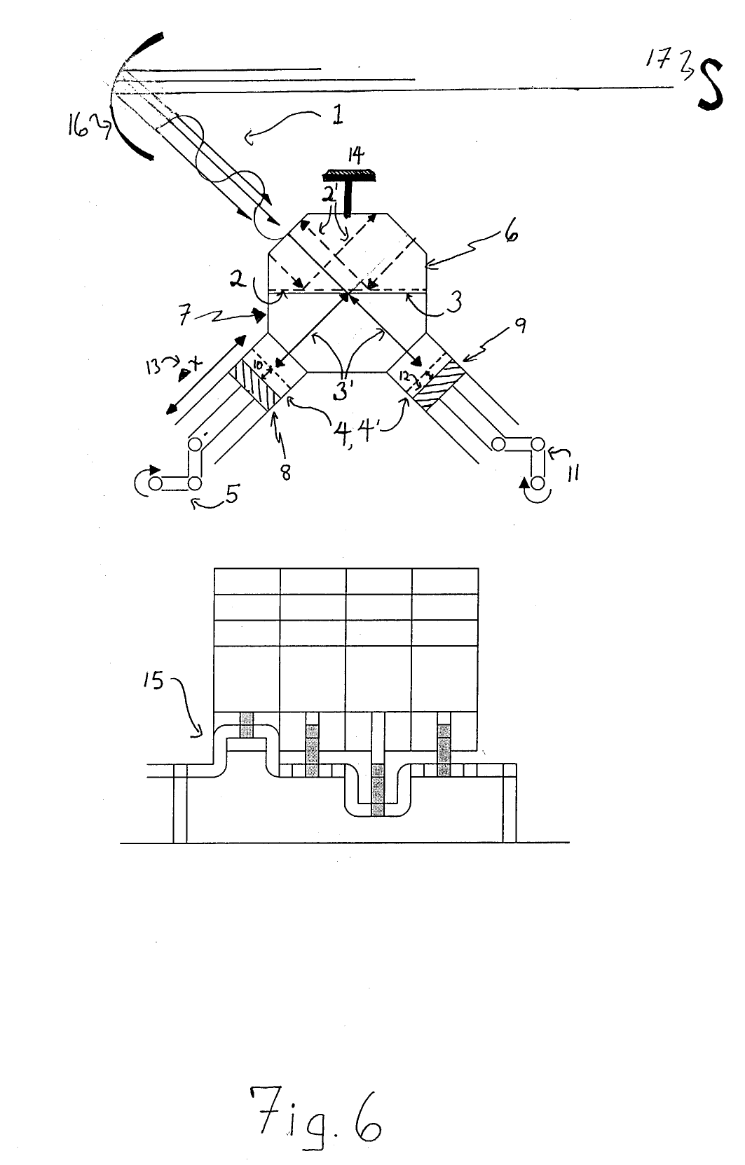

FIG. 6 is a schematic illustrating operation of an inventive apparatus, i.e., a a multi-cylinder Photon Engine. The Engine comprises: a plurality of cylinders (e.g. 8, 9); crankshaft and connecting rod assemblies (5, 11); pistons/mirror assemblies (10, 12); a secondary prism (7); primary prism (6); prism piezoelectric drive mechanism (14); Compression Boundary Light Switch (CBLS), shown as either closed (2) or open (3). In practice, light (1) enters the primary prism (6) which may be in one of two positions(shown by 2-closed or 3-open), the position effectuated by the CBLS drive mechanism (14). If the CBLS is closed then incident radiation (1) will remain in primary prism (6) as shown by dashed lines) 2′). If the piezoelectric drive mechanism (14) is then engaged, thereby effectively removing the interface as defined by (3) then light can pass through and generate radiation pressure on mirror/pistons (10 and 12) thereby displacing them a distance delta x as suggested by (13) and thereby causing crankshaft 5 to turn thus generating mechanical energy. In another mode the CBLS (14) may be operated in a frequency modulated mode so that the opening and closing of the light switch allows light to enter the secondary prism (7) on a time scale related to the frequency of the radiation inside the secondary prism thereby reinforcing the radiation pressure/driving force on the mirrors/piston. and driving crankshaft 15.

It should be understood, however, that various arrangements and deployments of the components of inventive apparatus in accordance with the invention may be made and will vary according to the particular environment and applications. However, in any such applications, various aspects of the inventions will be applicable, as described above. For example, various aspects of the photon engine, such as the containment chamber design or the optical switching devices may be incorporated with other engine or mechanical work devices. As a further example, the piston and cylinder assembly may be replaced by another energy system such a energy storage device (e.g., a spring device).

The foregoing description of the present invention has been presented for purposes of illustration and description. It is to be noted that the description is not intended to limit invention to the apparatus, and method disclosed herein. Various aspects of the invention as described above may be applicable to other types of engines and mechanical work devices and methods for harnessing radiation pressure to generate mechanical work. It is to be noted also that the invention is embodied in the method described, the apparatus utilized in the methods, and in the related components and subsystems. These variations of the invention will become apparent to one skilled in the optics, engine art, or other relevant art, provided with the present disclosure. Consequently, variations and modifications commensurate with the above teachings and the skill and knowledge of the relevant art are within the scope of the present invention. The embodiments described and illustrated herein are further intended to explain the best modes for practicing the invention, and to enable others skilled in the art to utilize the invention and other embodiments and with various modifications required by the particular applications or uses of the present invention.

What is claimed is:

1. A method of utilizing radiation pressure provided by a light wave to generate mechanical work, said method comprising the steps of:
providing a containment chamber for containing propagation of a light wave;
positioning, in a first location of the containment chamber, a movable reflective mirror having a first reflective surface and, in a second location in the containment chamber, a second reflective surface, whereby the locations and orientations of the first and second reflective surfaces are predetermined to define, at least partially, a predetermined reflective light path;
introducing a light wave into the containment chamber, said introducing step including directing the introduced light wave in the direction of one of the reflective surfaces, thereby contacting, initially, the reflective surface and causing radiation pressure to act on the initial reflective surface, and then to reflect against the initial reflective surface at a generally normal angle,
whereby the reflected light wave is caused to travel along the predetermined path such that the reflected light wave reflects against the other reflective surface at a generally normal angle, and returns in the direction of the initial reflective light path such that the light wave is again caused to reflect against the initial reflective surface at a generally normal angle, and such that the light wave continues to propagate between the reflective surfaces along the predetermined light path for a plurality of cycles and radiation pressure to repeatedly act upon the initial reflective , thereby effecting travel of the initial reflective surface along a predetermined path and producing mechanical work.

2. The method of claim 1, wherein said initial reflective surface is the first reflective surface such that said step of directing the introduced light wave includes directing the light wave in the direction of said first reflective surface.

3. The method of claim 1, wherein said positioning step includes the step of positioning a second movable reflective mirror in the containment chamber, the second reflective mirror having the second reflective surface.

4. The method of claim 3, wherein said step of directing the introduced light wave causes the light wave to repeatedly contact the second reflective surface and radiation pressure to repeatedly act upon the second reflective surface, thereby effecting travel of the second reflective surface along a second predetermined path and producing mechanical work.

5. The method of claim 1, further comprising the step of providing a prism and positioning the prism such that the prism volume forms a portion of the containment chamber and at least one face prism forms a boundary of the containment chamber.

6. The method of claim 5, wherein said introducing step includes directing the light wave into the prism through said one face.

7. The method of claim 6, further comprising the steps:
optically opening said one face of the prism, before the introducing step, such that the light wave enters the containment chamber through said one face; and
after the introducing step, closing said one face, such that the directing step causes the reflected light wave to repeatedly reflect against said one face.

8. The method of claim 7, wherein said positioning step includes the step of positioning a second movable reflective mirror in the containment chamber, the second reflective mirror having the second reflective surface, and wherein the directing step causes the light wave to propagate between the first reflective surface, the second reflective surface, and said one face of the prism.

9. The method of claim 7, further comprising the step of providing a second prism and positioning the second prism such that one face is positioned adjacent said one face of the first prism; and,
wherein said step of opening said one face includes compressing said one face of said first prism against said one face of said second prism, such that said compressed faces form a transparent interface.

10. The method of claim 7, further comprising the steps of:
after termination of a plurality of cycles, repeating said step of opening said one face of the first prism, repeating said introducing step with another light wave, and repeating said step of closing said one face of said first prism, whereby repeated contact of said first or second reflective surface causes radiation pressure to move the reflective surface along a predetermined path to generate mechanical work.

11. The method of claim 1, wherein the movable reflective mirror is operatively associated with a piston and cylinder assembly such that movement of the firs reflective causes the piston to travel along a predetermined path thereby generating mechanical work.

12. A method of utilizing radiation pressure provided by a light wave to generate mechanical work, said method comprising the steps of:
providing a containment chamber for containing propagation of a light wave;
positioning, in a first location of the containment chamber, a movable reflective mirror having a first reflective surface and, in a second location in the containment chamber, a second reflective surface, whereby the locations and orientations of the first and second reflective surfaces are predetermined to define, at least partially, a predetermined reflective light path;
introducing a light wave into the containment chamber, said introducing step including directing the introduced light wave in the direction of one of the reflective surfaces, thereby causing the light wave to propagate between the first and second reflective surfaces along a predetermined light path for a plurality of cycles, whereby the light wave contacts the first reflective surface and causes radiation pressure to act on the first reflective surface, and then reflects against the initial reflective surface at a generally normal angle.

13. The method of claim 12, further comprising the step of repeating the introducing step with respect to another light wave, whereby repeated contact of the first reflective surface with the light wave causes radiation pressure to move the first reflective surface along a predetermined path.

14. The method of claim 13, wherein said positioning step includes the step of positioning a second movable reflective mirror in the containment chamber, the second reflective mirror having the second reflective surface, and wherein said step of directing the introduced light wave causes the light wave to repeatedly contact the second reflective surface and radiation pressure to repeatedly act upon the second reflective surface, thereby effecting travel of the second reflective surface along a second predetermined path and producing mechanical work.

15. The method of claim 14, further comprising the step of providing a prism and positioning the prism such that the prism volume forms a portion of the containment chamber and at least one face prism forms a boundary of the containment chamber, and wherein said introducing step includes directing the light wave into the prism through said one face.

16. The method of claim 15, further comprising the steps:
optically opening said one face of the prism, before the introducing step, such that the light wave enters the containment chamber through said one face; and
after the introducing step, closing said one face, such that the directing step causes the reflected light wave to repeatedly reflect against said one face.

17. The method of claim 16, further comprising the step of providing a second prism and positioning the second prism such that one face is positioned adjacent said one face of the first prism; and,
wherein said step of opening said one face includes compressing said one face of said first prism against said one face of said second prism, such that said compressed faces form a transparent interface.

18. An apparatus for utilizing radiation pressure provided by a light wave to generate mechanical work, said apparatus comprising:
a containment chamber constructed to contain the propagation of light waves therein along a predetermined reflected light wave path;
an optic switch selectively operable in an open mode and a closed mode, wherein said open mode allows a light wave to enter said containment chamber and said closed mode prevents escape of the light wave from the containment chamber;
a reflective mirror positioned at one end of said containment chamber, said reflective mirror having a first reflective surface; and
a second reflective surface positioned at a second end of said containment chamber, wherein the predetermined light path extends between said first and second reflective surfaces; and
wherein repeated contact of the light path against the first reflective surface allows radiation pressure repeatedly acting upon the first reflective surface to cause the movable reflective mirror to travel along a predetermined path, thereby producing mechanical work.

19. The apparatus of claim 1, further comprising a second movable reflective mirror positioned at said second end of said containment chamber, said second reflective mirror having said second reflective surface.

20. The apparatus of claim 19, further comprising:
a first prism positioned in the containment chamber such that the volume of the first prism provides a portion of the containment chamber and such that one face of said first prism provides a gate for said optic switch; and
a second prism positioned adjacent the containment chamber such that a face of said second prism is positioned adjacent said one face of said first prism, such that compression between said first and second prism operates said optic switch between said open and closed modes.

21. The apparatus of claim 20, further comprising:
a first piston and a second piston, each said piston being operatively associated with a corresponding first or second movable reflective mirror, such that movement of said movable reflective mirror effects travel of said piston.

22.
